(19) United States
(12) Patent Application Publication
(10) Pub. No.: US 2026/0260334 A1
(43) Pub. Date: Sep. 3, 2026

(54) IMAGE GENERATING METHOD AND VISUAL INSPECTION DEVICE

(71) Applicant: Hitachi, Ltd., Tokyo (JP)

(72) Inventors: Takehiro MAEDA, Tokyo (JP); Atsushi MIYAMOTO, Tokyo (JP); Mayuka OSAKI, Tokyo (JP); Hiroaki KASAI, Tokyo (JP)

(21) Appl. No.: 18/871,519

(22) PCT Filed: Apr. 12, 2023
(86) PCT No.: PCT/JP2023/014872

§ 371 Date: Dec. 4, 2024

(30) Foreign Application Priority Data
Jun. 16, 2022 (JP) 2022-097546

(51) Int. Cl. G06T 7/00; G06T 7/70

(52) U.S. Cl. CPC G06T 7/001; G06T 7/70; G06T 2207/20081; G06T 2207/30164

(57) ABSTRACT

The present invention addresses the problem of suppressing inaccurate determination of the presence absence of abnormalities through machine learning. Provided is an external appearance inspection device comprising a processor. The processor acquires a plurality of external-appearance images in which an external appearance to be inspected is photographed, generates a statistical distribution representing variations in characteristics in each of the external-appearance images when the plurality of external-appearance images are used as a population, generates, on the basis of the variations revealed by the statistical distribution, an additional image in which the external appearance is photographed, and generates a trained model through machine learning in which training data including the plurality of external-appearance images and the additional image is used.

### TECHNICAL FIELD

The present invention relates to an image generating method and a visual inspection device. The present invention claims the priority to Japanese Patent Application No. 2022-097546 filed on Jun. 16, 2022, and the content described in the application is incorporated herein by reference for designated states that accept the incorporation by reference to literature.

### BACKGROUND ART

In a manufacture line or the like manufacturing products, finding of a defect early is performed by recognizing whether there is a defect in a product being manufactured or a part in the product by image recognizing technique. Particularly, with development of machine learning in recent years, finding of a defect by machine learning is actively performed. In this case, a machine learning model such as CNN (Convolutional Neural Network) is made learn various learning images and, after that, the machine learning model which has learned the images determines whether a product has a defect or not on the basis of an actual image of the product.

However, when varieties of learning images are small, learning of the machine learning model is insufficient, and determination of whether a product has a defect or not becomes inaccurate. The patent literature 1, consequently, proposes a technique of increasing varieties of a learning image by extracting a scratch from a learning image, generating partial images obtained by variously deforming the scratch, and creating new learning images by synthesizing the partial images to images to be synthesized.

### CITATION LIST

### Patent Literature

Patent Literature 1: Japanese Unexamined Patent Application Publication No. 2019-109563

### SUMMARY OF INVENTION

### Technical Problem

The frequency, however, that a defect occurs in a product varies among defects. Consequently, when the varieties of a learning image are increased without considering the frequency, there is the possibility that a machine learning model erroneously detects a defect or overlooks a defect, and the result of determination of the machine learning model becomes inaccurate.

The present invention has been made in consideration of such circumstances and an object of the invention is to suppress inaccurate determination on the presence/absence of an abnormality by machine learning.

### Solution to Problem

The present application includes a plurality of means for solving at least a part of the above-described problems. An example of the means is as follows.

In order to solve the above problems, a visual inspection device according to one aspect of the present invention has a processor, and the processor obtains a plurality of visual images of visual of an object to be inspected, generates a statistical distribution expressing variation in a characteristic of each of the visual images when the plurality of visual images are set as a population, generates an additional image of the visual on the basis of the variation indicated by the statistical distribution, and generates a learned model by machine learning using learning data including the plurality of visual images and the additional images.

### Advantageous Effects of Invention

According to the present invention, it is possible to suppress inaccurate determination on the presence/absence of an abnormality by machine learning.

Objects, configurations, and effects other than the above will be apparent from the description of the following embodiments.

### BRIEF DESCRIPTION OF DRAWINGS

FIG. 1 is a schematic diagram illustrating an example of a functional configuration of a visual inspection device.

FIG. 2 is a schematic diagram illustrating an example of a flowchart of a visual inspecting method according to a first embodiment.

FIG. 3 is a flowchart illustrating an example of a process of generating an additional image according to the first embodiment.

FIG. 4 is a schematic diagram for explaining an example of the process of generating an additional image according to the first embodiment.

FIG. 5 is a schematic diagram for explaining an example of the process of generating an additional image according to the first embodiment in the case of employing a position where a deformation occurs in a part as a characteristic of the visual image.

FIG. 6 is a schematic diagram for explaining an example of the process of generating an additional image according to the first embodiment in the case where luminance of an entire visual image is employed as a characteristic of the visual image.

FIG. 7 is a schematic diagram for explaining an example of the process of generating an additional image according to the first embodiment in the case where contrast of a visual image is employed as a characteristic of the visual image.

FIG. 8 is a schematic diagram for explaining an example of the process of generating an additional image according to the first embodiment in the case where noise intensity of a visual image is employed as a characteristic of the visual image.

FIG. 9 is a schematic diagram illustrating an example of a method of generating a learned model according to the first embodiment.

FIG. 10 is a schematic diagram illustrating an example of an inspection method according to the first embodiment.

FIG. 11 is a schematic diagram illustrating a display example of a display unit according to the first embodiment.

FIG. 12 is a schematic diagram for explaining an example of a process of generating an additional image in a second embodiment.

FIG. 13 is a schematic diagram illustrating an example of a method of generating a learned model in a third embodiment.

FIG. 14 is a schematic diagram illustrating an example of an inspection method in the third embodiment.

FIG. 15 is a diagram illustrating an example of the hardware configuration of a visual inspection device according to the first to third embodiments.

### DESCRIPTION OF EMBODIMENTS

One embodiment according to the present invention will now be described with reference to the drawings. It should be noted that in the all accompanying drawings, constituting elements having the same function configurations are indicated by the same reference numerals, and the repetitive description is thus omitted. In the following embodiments, except the case where it is clearly described, the case where a component is regarded to be apparently essential in principle, and the like, obviously, a component (including an elemental step or the like) is not always necessary. Expressions such as “made from A”, “made by A”, “having A” and “including A” obviously do not exclude other elements unless otherwise clearly described that A is only the element. Similarly, in the following embodiments, when the shapes, positional relations, and the like of components and the like are referred to, it is assumed those substantially close or similar to them are included except the case where it is clearly described, the case where they are apparently considered to be different in principal, and the like.

### FIRST EMBODIMENT

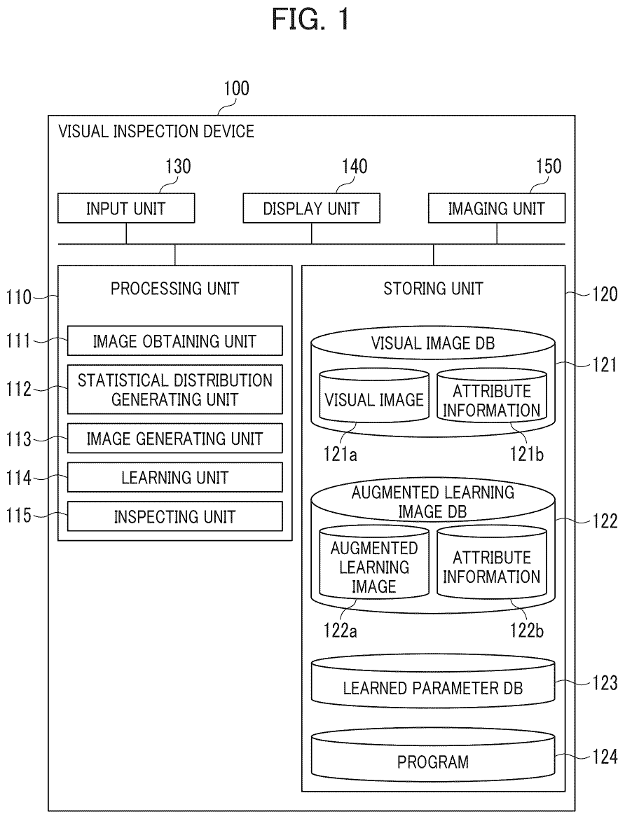

FIG. 1 is a schematic diagram illustrating an example of the functional configuration of a visual inspection device 100 according to a first embodiment.

The visual inspection device 100 is a device that inspects whether there is an abnormality in the visual of, for example, a part as an object to be inspected and includes a processing unit 110, a storing unit 120, an input unit 130, a display unit 140, and an imaging unit 150.

The input unit 130 is an input device such as a keyboard or a mouse for receiving various inputs from the user. The display unit 140 is a display device such as, for example, a liquid crystal display or an EL (electro luminescence) display which displays a result of inspection of the visual of a part or the like.

The imaging unit 150 is an imaging device such as a camera which captures an image of the visual of a part as an object to be inspected and stores a visual image 121a of the visual into the storing unit 120.

The storing unit 120 is a functional unit which stores each of a visual image DB (database) 121, an augmented learning image DB 122, a learned parameter DB 123, and a program 124.

The visual image DB 121 is a database storing a visual image 121a of a part captured by the imaging unit 150 and its attribute information 121b. The attribute information 121b is information including information indicating whether the part appearing in the visual image 121a is normal or abnormal, and information including the kind of an abnormality and the position where the abnormality occurs in the part.

The augmented learning image DB 122 is a database storing an augmented learning image 122a and attribute information 122b. The augmented learning image 122a is learning data used when a machine learning model that inspects whether there is an abnormality in a part performs learning. As an example, the augmented learning image 122a is an image including the above-described visual image 121a and an additional image generated by an image generating unit 113 which will be described later. By using not only the visual image 121a but also an additional image as learning data, varieties of learning data can be increased.

The attribute information 122b is information including information indicating whether a part appeared in the augmented learning image 122a is normal or abnormal, the type of an abnormality, and the position where the abnormality occurs in the part.

The learned parameter DB 123 is a database storing an internal parameter of a machine learning model which learned the augmented learning image 122a as learning data.

The program 124 is a visual inspection program according to the embodiment. When the program 124 is executed by the visual inspection device 100, the functions of the processing unit 110 are realized.

The processing unit 110 is a function unit controlling components of the visual inspection device 100. As an example, the processing unit 110 has an image obtaining unit 111, a statistical distribution generating unit 112, an image generating unit 113, a learning unit 114, and an inspecting unit 115.

The image obtaining unit 111 is a function unit obtaining the visual image 121a from the visual image DB 121.

The statistical distribution generating unit 112 is a processing unit of generating a statistical distribution expressing variations of the characteristic of each of the visual images 121a when a plurality of visual images 121a are set as a population. An example of the characteristic is, as will be described later, a deformation amount of a part as an object to be inspected or the position where a deformation occurs in a part. The luminance, contrast, and noise intensity of each of the visual images 121a are also examples of the characteristics.

The image generating unit 113 is a function unit which generates an additional image of the visual of a part on the basis of variations of the characteristic indicated by the statistical distribution generated by the statistical distribution generating unit 112, and stores it as the augmented learning image 122a into the augmented learning image DB.

The learning unit 114 is a function unit of generating a learned model by machine learning using the augmented learning image 122a as learning data.

The inspecting unit 115 is a function unit of inspecting whether the visual of a part to be inspected has an abnormality or not by using the learned model. The inspecting unit 115 may instruct the display unit 140 to display an inspection result or the like so that the user viewing the display unit 140 can grasp the inspection result.

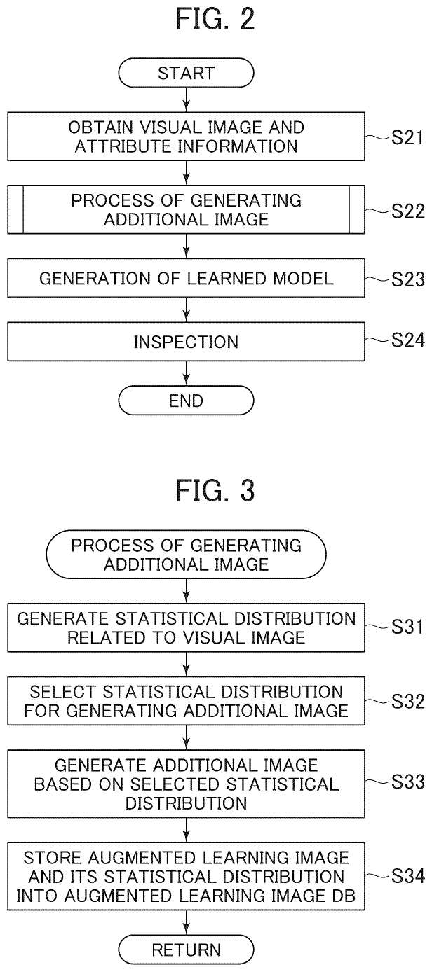

FIG. 2 is a schematic diagram illustrating an example of a flowchart of the visual inspection method according to the present embodiment.

First, the image obtaining unit 111 obtains one or more visual images 121a from the visual image DB 121 (step S21). In this example, the image obtaining unit 111 obtains one or more normal visual images 121a at random from all of visual images 121a stored in the visual image DB 121. The image obtaining unit 111 can determine whether the visual image 121a is normal or not on the basis of the attribute information 121b corresponding to the visual image 121a. Further, the image obtaining unit 111 also obtains the attribute information 121b corresponding to each of the obtained visual images 121a from the visual image DB 121.

Subsequently, the statistical distribution generating unit 112 and the image generating unit 113 perform a process of generating an additional image (step S22). The details of the generating process will be described later.

The learning unit 114 generates a learned model by machine learning using the augmented learning image 122a as learning data (step S23). The details of this step will be described later.

The inspecting unit 115 inspects whether there is an abnormality in a part by using the learned model (step S24). In this case, the inspecting unit 115 obtains an inspection image of the part captured by the imaging unit 150 and inspects whether there is an abnormality in the part appeared in the inspection image. The details will be described later.

By the above, the basic process of the visual inspection method according to the embodiment is finished.

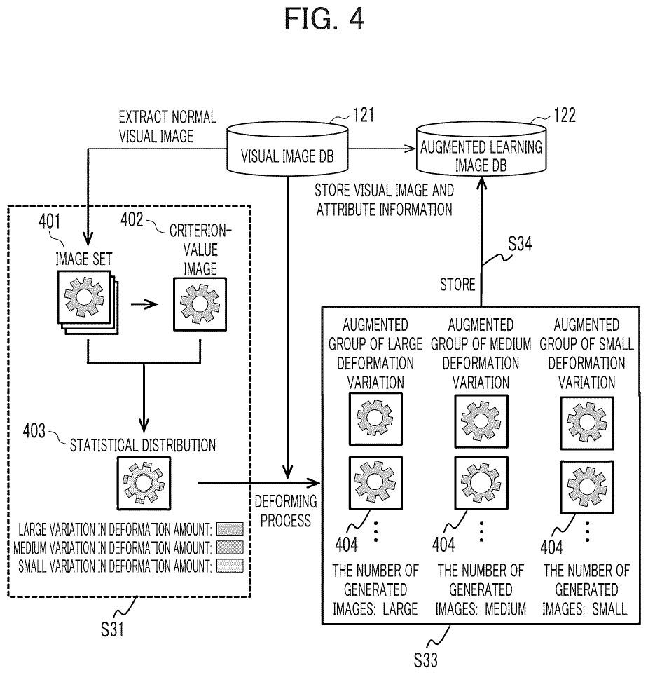

Next, the process of generating an additional image in step S22 will be described. FIG. 3 is a flowchart illustrating an example of the process of generating an additional image. FIG. 4 is a schematic diagram for explaining an example of the process of generating an additional image. The process of generating an additional image is an example of the image generating method.

As illustrated in FIG. 3, the statistical distribution generating unit 112 generates a statistical distribution expressing variations in the characteristics of the visual images 121a when the visual images 121a obtained in step S21 are used as a population (step S31).

In the example of FIG. 4, the visual images 121a as a population of the statistical distribution are expressed as an image set 401. The statistical distribution generating unit 112 generates a criterion-value image 402 from the visual images 121a included in the image set 401. In this example, the statistical distribution generating unit 112 calculates the median value of pixel values of each visual image 121a at each position, and generates a median-value image in which the pixel value at each position is the median value as a criterion-value image. In place of the median value, an average value of pixel values may be employed. The median value may be calculated at the position of each pixel or in an area including a plurality of pixels. Subsequently, the statistical distribution generating unit 112 obtains the difference in pixel values between each of the visual images 121a and the criterion-value image 402 at each of positions. The difference calculated at a certain position is a deformation amount at the position in the part appeared in the visual image 121a in the case where the criterion-value image 402 is used as a criterion. The statistical distribution generating unit 112 obtains a cumulative value derived by totaling the differences in the visual images 121a at each position. A position at which the cumulative value is large is a position where variation in the deformation amount is large when the image set 401 is used as a population. On the contrary, a position at which the cumulative value is small is a position where variation in the deformation amount is small when the image set 401 is used as a population. The statistical distribution generating unit 112 generates a statistical distribution 403 obtained by mapping the cumulative values. A position where the color is dark in the statistical distribution 403 is a position where the variation in the deformation amount is large, and a position where the color is light is an area where the variation in the deformation amount is small.

Although the statistical distribution generating unit 112 generates the statistical distribution 403 indicating the variation in the deformation amount at each of positions in a part in this case, the statistical distribution generating unit 112 may generate a plurality of kinds of statistical distributions 403. For example, the statistical distribution generating unit 112 may generate a statistical distribution indicating the variation in the shape of a part as will be described later, or may generate a statistical distribution indicating the variation in each of luminance, contrast, and noise intensity of each of the visual images 121a.

FIG. 3 is referred to again. The image generating unit 113 selects one or more statistical distribution from the plurality of statistical distributions generated by the statistical distribution generating unit 112 (step S32). To make explanation simpler, the case where the image generating unit 113 selects the above-described statistical distribution 403 indicating variation in the deformation amount will be described as an example.

The image generating unit 113 generates an additional image on the basis of the selected statistical distribution 403 (step S33). A method of generating an additional image will be described with reference to FIG. 4.

As the statistical distribution 403 illustrates, the variation in the deformation amount differs according to the positions in the part. It is considered that, the number of the visual images 121a included in the visual image DB 121, of the visual images 121a of a deformed part imaged in positions where the variation is large is statistically smaller and the varieties are smaller as compared with the visual images 112a of the deformed part imaged in positions where the variation is small.

The image generating unit 113 therefore generates additional images 404 obtained by performing deforming process on the visual images 121a included in the visual image DB 121 to increase the varieties of deformation. The deformation amount and the number of additional images 404 are determined by the image generating unit 113 on the basis of the statistical distribution 403. For example, the larger the variation in the statistical distribution 403 in a distribution region is, the more the image generating unit 113 increases the deformation amount and the number of additional images 404. The visual image 121a to be subjected to the deforming process may be one visual image 121a arbitrarily selected from the visual image DB 121 or a plurality of visual images 121a. In such a manner, varieties of the additional image 404 having large variation can be increased.

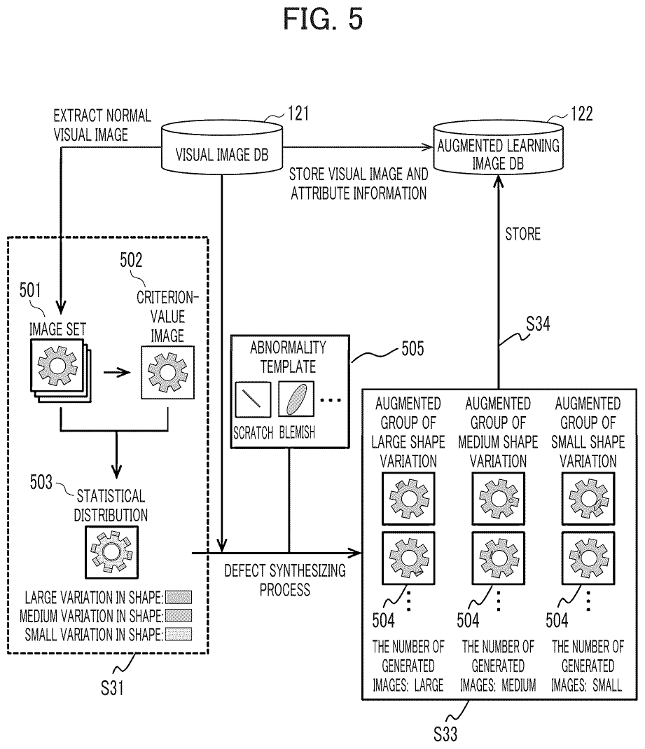

The image generating unit 113 makes the deformation amount in the additional image 404 within the distribution range in the statistical distribution 403 of the normal visual image 121a. Consequently, the part appearing in the additional image 404 can be regarded as normal. The visual image 121 which becomes the additional image 404 by the deforming process may be normal or abnormal. By performing the deforming process on the visual image 121 which is normal or abnormal as described above, the image generating unit 113 may generate an abnormal additional image 404. This manner also applies to examples in FIGS. 5 to 8 which will be described later.

Subsequently, the image generating unit 113 stores all of the visual images 121a included in the visual image DB 122 and all of additional images 404 generated in step S33 into the augmented learning image DB 122 (step S34). The image generating unit 113 stores the attribute information 121b of the visual images 121a into the augmented learning image DB 122 and also stores the attribute information 122b of the additional images 404 into the augmented learning image DB 122. Since the normal visual images 121a are the image set 401 in this case, as described above, the part appearing in the additional image 404 can be also regarded as normal. Consequently, the attribute information 122b of the additional image 404 is information indicating that the part is normal.

By the above, the basic process in the process of generating an additional image is finished.

The visual images 121a and the additional images 404 in the augmented learning image DB 122 generated as described above are learning data which is used when the learning unit 114 generates a learned model. Since the number of the additional images 404 in a distribution region in which variation of the deformation amount in the statistical distribution 403 is large is increased as described above in the embodiment, varieties of the learning data in the distribution region increase. Consequently, the learning unit 114 can accurately learn a discrimination border distinguishing between normality and abnormality on the basis of the learning data. As a result, the possibility that the inspecting unit 115 erroneously determines that a part which is largely deformed within a normal range is abnormal can be reduced, and it can suppress that the determination of the presence/absence of an abnormality by machine learning becomes inaccurate.

FIG. 5 is a schematic diagram for explaining an example of a process of generating the additional image 404 in the case of employing a position where deformation occurs in a part as a characteristic of the visual image 121a.

In the example of FIG. 5, a plurality of visual images 121a as a population of the statistical distribution are expressed as an image set 501. In step S31, the statistical distribution generating unit 112 extracts the shape of each of visual images 121a included in the image set 501 by an image process such as outline extraction. Subsequently, the statistical distribution generating unit 112 generates a median-value image indicating the median value of the shapes of parts in the image set 501 as a criterion-value image 502. The statistical distribution generating unit 112 may generate an average-value image indicating an average value of the shapes of the parts in the image set 501 in place of the median-value image.

Further, the statistical distribution generating unit 112 calculates the difference of pixel values between each of the visual images 121a included in the image set 501 and the criterion-value image 502 at each of positions, thereby calculating the position where deformation occurs in the part for each of the visual images 121a in the case where the criterion-value image 502 is set as a criterion. The statistical distribution generating unit 112 generates a statistical distribution 503 indicating variation in the position where deformation occurs in the case where the image set 501 is used as a population.

In this example, an abnormality template 505 in which images of various defects such as a scratch and a blemish are stored is stored in the storing unit 120 in advance. In step S33, the image generating unit 113 generates images in which the shape of a part is variously deformed within the normal range by performing the image process or the like on the visual images 121a included in the visual image DB 121. For example, the larger the variation is in the distribution region in the statistical distribution 503, the more the image generating unit 113 generates images in which the deformation is large for the distribution region.

The image generating unit 113 may obtain one arbitrary visual image 121a from the visual image DB 121 and perform the above-described image process on the visual image 121a. Alternatively, the image generating unit 113 may obtain a plurality of visual images 121a from the visual image DB 121 and perform the image process on each of the visual images 121a. The image generating unit 113 generates an additional image 504 obtained by superimposing (synthesizing) a defect image in the abnormality template 505 on the image subjected to the image process as described above.

The position in which the defect image is superimposed on a visual image 121a is the position where deformation occurs in the visual image 121a. For example, in the case where deformation occurs in the periphery of a part in a certain visual image 121a, the image generating unit 113 superimposes the defect image on the periphery.

The image generating unit 113 may perform a process of any of rotation, enlargement, and reduction or a combination of them on the defect image in the abnormality template 505 and superimpose the processed image on the visual image 121a.

Although a defect image is included in the additional image 504, the image as the base of the additional image 504 is an image in which the shape of a part is deformed within a normal range. Therefore, the attribute information 122b of the additional image 504 stored in the augmented learning image DB 122 in step S34 is information indicating that the image is normal.

The visual images 121a in which the position where a deformation occurs in a part variously varies are included in the visual image DB 121. Like in the example of FIG. 4, it is considered that the number of visual images 121a in a distribution region where the variation is large in the statistical distribution 503 is smaller and the varieties are smaller as compared to the visual image 121a in a distribution region where the variation is small.

Consequently, by generating the additional images 504 like this example, the varieties of images can be increased, and varieties of learning data becomes richer. Further, by superimposing a defect image on the visual image 121a, the combinations between deformations and defects become rich, and the varieties of leaning data further increase.

Therefore, the learning unit 114 can accurately learn the discrimination border for distinguishing between normality and abnormality on the basis of learning data in which a defect exists in a position where a deformation occurs. As a result, the possibility that the inspecting unit 115 erroneously determines the shape variation within the normal range as an abnormality can be decreased.

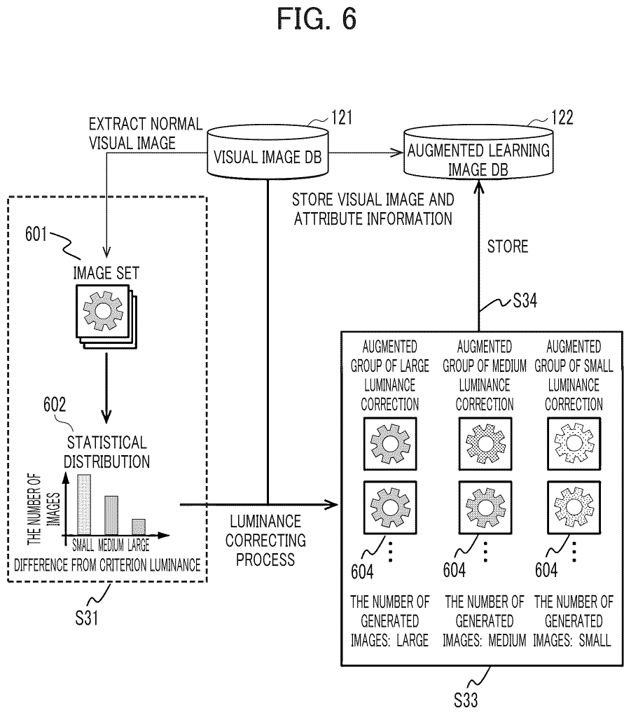

FIG. 6 is a schematic diagram for explaining an example of a process of generating an additional image in the case of employing luminance of the entire visual image 121a as a characteristic of the visual image 121a.

In the example of FIG. 6, a plurality of visual images 121a as a population of the statistical distribution are expressed by an image set 601. In step S31, the statistical distribution generating unit 112 calculates average luminance obtained by averaging the luminance of the entire visual image 121a by the image set 601 as a criterion luminance. The statistical distribution generating unit 112 may calculate, in place of the average luminance, the median value of luminance in the image set 601 as a criterion luminance.

Further, the statistical distribution generating unit 112 calculates the difference between luminance of the entire image and the criterion luminance for each of the visual images 121a included in the image set 601, and generates a statistical distribution 602 indicating variation of the difference. The horizontal axis of the statistical distribution 602 indicates the difference between the criterion luminance and the luminance, and the vertical axis indicates the number of visual images 121a.

In step S33, the image generating unit 113 properly selects the visual image 121a from the visual image DB 121. The number of visual images 121a to be selected may be one or plural. By performing a luminance correcting process on the selected visual image 121a, the image generating unit 113 generates various additional images 604 so that the difference between the criterion luminance and the luminance lies within the distribution range in the statistical distribution 602 only by the number according to the statistical distribution 602.

For example, the smaller the number of the visual images 121a in a distribution region in the statistical distribution 602 is, the more the image generating unit 113 increases the number of additional images 604 for the distribution region. In such a manner, the varieties of images of which number is small in the statistical distribution 602 can be increased.

Since the difference between the luminance of the additional images 604 and the criterion luminance lies within the distribution range in the statistical distribution 602 of the normal visual image 121a, a part appearing in the additional image 604 can be regarded as a normal part. Consequently, the attribute information 122b of the additional image 604 stored in the augmented learning image DB 122 in step S34 is information indicating normality.

Since the varieties of the images of which number is small in the statistical distribution 602 increase in this example, the varieties of luminance in learning data become richer, and bias of luminance in learning data can be reduced. Consequently, the learning unit 114 can learn the visual of a normal part in consideration of the color of a part to be inspected. As a result, the possibility that the inspecting unit 115 erroneously determines that a normal part is an abnormal one due to the difference in colors.

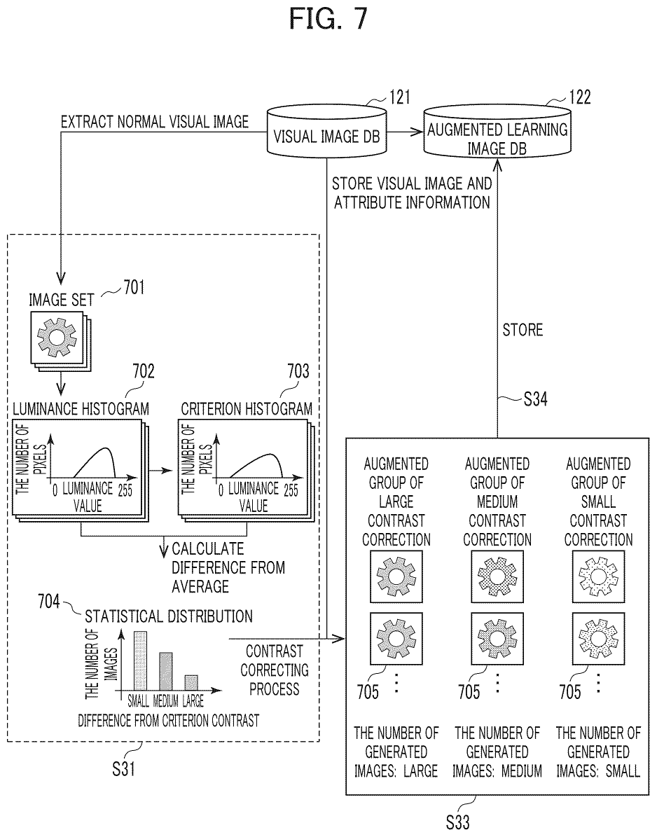

FIG. 7 is a schematic diagram for explaining an example of a process of generating an additional image in the case of employing contrast of the visual image 121a as a characteristic of the visual image 121a.

In the example of FIG. 7, a plurality of visual images 121a as a population of the statistical distribution is expressed by an image set 701. In step S31, the statistical distribution generating unit 112 calculates a luminance histogram 702 in which a luminance value and the number of pixels are associated for each of the visual images 121a included in the image set 701. Subsequently, the statistical distribution generating unit 112 calculates, as a criterion histogram 703, an average luminance histogram obtained by averaging the luminance histograms 702 in the image set 701.

Further, the statistical distribution generating unit 112 calculates, for example, a criterion contrast on the basis of the difference between the maximum luminance and the minimum luminance in the criterion histogram 703. Similarly, the statistical distribution generating unit 112 calculates the contrast of each of the visual images 121a included in the image set 701 on the basis of the difference between the maximum luminance and the minimum luminance in each luminance histogram 702. The statistical distribution generating unit 112 calculates the difference between the contrast of each of the visual images 121a and the criterion contrast, and generates the statistical distribution 704 indicating the variation in the difference. The horizontal axis of the statistical distribution 704 indicates the difference between the criterion contrast and the contrast, and the vertical axis indicates the number of visual images 121a.

In step S33, the image generating unit 113 properly selects the visual image 121a from the visual image DB 121. The number of visual images 121a to be selected may be one or plural. The image generating unit 113 performs a contrast correcting process on the selected visual image 121a, thereby generating various additional images 705 in which the difference between the criterion contrast and the contrast lies within the range of the distribution in the statistical distribution 704 only by the number of images according to the statistical distribution 704.

As an example, the smaller the number of the visual images 121a in the distribution region in the statistical distribution 704 is, the more the image generating unit 113 increases the number of additional images 705 having the variation. In such a manner, the varieties of images of which number is small in the statistical distribution 704 can be increased.

Since the difference between the contrast of the additional image 705 and the criterion contrast lies within the range of the distribution in the statistical distribution 704 of the normal visual image 121a, a part appearing in the additional image 705 can be regarded as a normal part. Consequently, the attribute information 122b of the additional image 705 stored in the augmented learning image DB 122 in step S34 is information indicating normality.

In this example, the varieties of the images of which number is small in the statistical distribution 704 increases, so that the varieties of the contrast in learning data become rich, and the bias of the contrast in the learning data is reduced. Consequently, the learning unit 114 can learn the visual of a normal part in consideration of the contrast of images. As a result, the possibility that the inspecting unit 115 erroneously determines a normal part as an abnormal one due to the difference of the contrast of an image can be decreased.

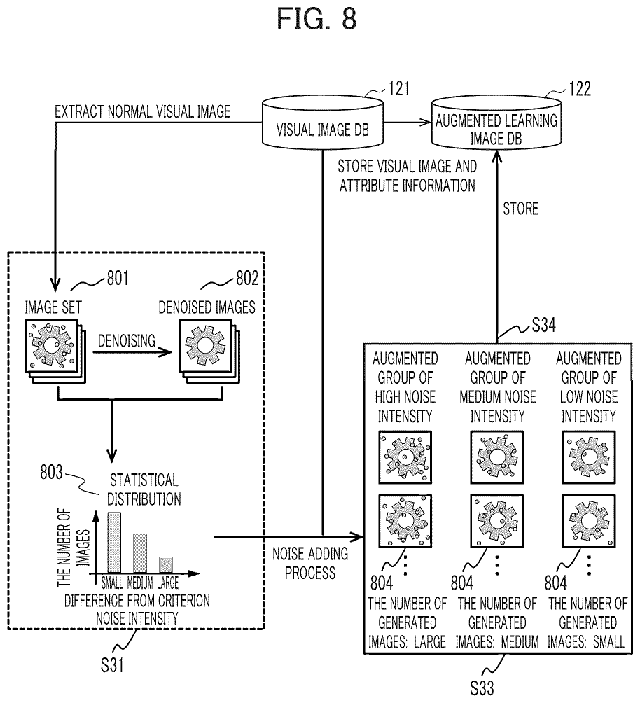

FIG. 8 is a schematic diagram for explaining an example of a process of generating an additional image in the case of employing the noise intensity of the visual image 121a as a characteristic of the visual image 121a.

In the example of FIG. 8, a plurality of visual images 121a as a population of the statistical distribution are expressed by an image set 801. In step S31, the statistical distribution generating unit 112 generates denoised images 802 obtained by removing noise in each of the visual images 121a included in the image set 801.

Subsequently, the statistical distribution generating unit 112 generates a difference image between each of the visual images 121a of the image set 801 and the corresponding denoised image 802, and calculates the average noise intensity in the whole difference image. The statistical distribution generating unit 112 calculates the average of the average noise intensities in the image set 801 as criterion noise intensity. The median value of the average noise intensities in the image set 801 may be set as the criterion noise intensity. Further, the statistical distribution generating unit 112 calculates the difference between the average noise intensity of the visual images 121a and the criterion noise intensity, and generates the statistical distribution 803 indicating the variation in the differences. The horizontal axis of the statistical distribution 803 indicates the difference between the criterion noise intensity and the average noise intensity, and the vertical axis indicates the number of visual images 121a.

In step S33, the image generating unit 113 properly selects the visual image 121a from the visual image DB 121. The number of visual images 121a to be selected may be one or plural. The image generating unit 113 performs noise adding process on the selected visual image 121a, thereby generating various additional images 804 such that the difference between the criterion noise intensity and the average noise intensity lies within the distribution range of the statistical distribution 803 only by the number according to the statistical distribution 803.

As an example, the smaller the number of the visual images 121a in the distribution region in the statistical distribution 803 is, the more the image generating unit 113 increases the number of additional images 804. In such a manner, the varieties of images of which number is small in the statistical distribution 803 can be increased.

Since the difference between the average noise intensity of the additional images 804 and the criterion noise intensity lies within the distribution range in the statistical distribution 803 of the normal visual image 121a, the part appearing in the additional image 804 can be regarded as a normal one. Consequently, the attribute information 122b of the additional image 804 stored in the augmented learning image DB 122 in step S34 is information indicating that it is normal.

According to the example, the varieties of images of which number is small in the statistical distribution 803 increases, so that the varieties of the average noise intensity in the learning data become rich, and bias of the average noise intensity in the learning data is reduced. Consequently, the learning unit 114 can learn the visual of a normal part in consideration of the average noise intensity of the images. As a result, the possibility that the inspecting unit 115 erroneously determines a normal part as an abnormal one due to the change in the noise intensity depending on the imaging environment can be reduced.

Next, a method of generating the learned model in step S23 in FIG. 2 will be described.

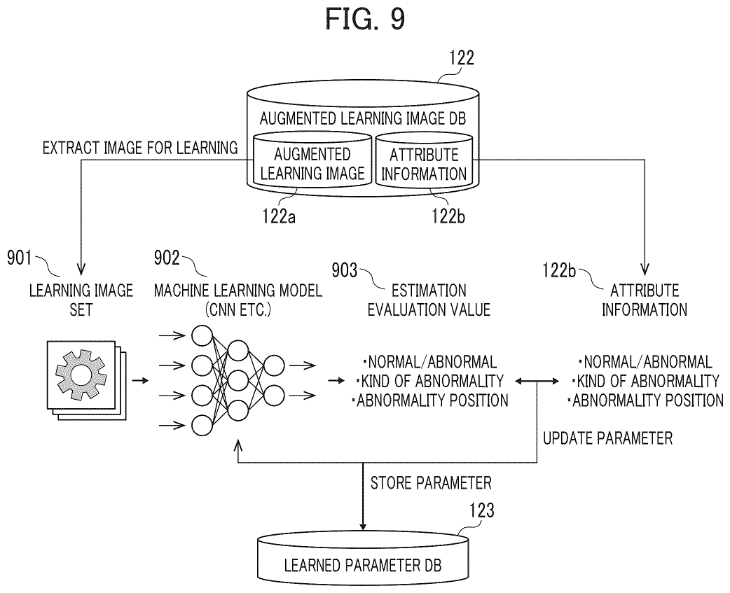

FIG. 9 is a schematic diagram illustrating an example of a method of generating a learned model.

First, the learning unit 114 obtains one or more augmented learning images 122a from the augmented learning image DB 122. A set of the augmented learning images 122a obtained in such a manner will be called a learning image set 901.

The learning unit 114 enters each of the augmented learning images 122a in the learning image set 901 as learning data to a machine learning model 902 such as CNN. The machine learning model 902 determines whether a part appearing in the augmented learning image 122a is normal or abnormal on the basis of the internal parameter, and outputs an estimation evaluation value 903 including the determination result. The estimation evaluation value 903 includes not only the result of the determination of whether a part is normal or abnormal but also the kind of an abnormality and the position where the abnormality occurs.

Subsequently, the learning unit 114 calculates an error between the estimation evaluation value 903 and the attribute information 122b, and updates the internal parameter of the machine learning model 902 so that the error becomes the minimum. The learning unit 114 stores the updated internal parameter into the learned parameter DB 123.

After that, the machine learning model 902 outputs the estimation evaluation value 903 by using the internal parameter stored in the learned parameter DB. The machine learning model 902 which outputs the estimation evaluation value 903 by using the internal parameter stored in the learned parameter DB as described above is a learned model.

By the above, the basic process performed at the time of generating a learned model is finished. In the example, the augmented learning image 122a in the learning image set 901 is selected from the augmented learning image DB 122 in which the varieties are increased by additional images of the number according to any of the above-described statistical distributions 403, 503, 602, 704, and 803, and is used as learning data of the machine learning model 902. Consequently, since the machine learning model 902 learns a variety of learning data, the possibility that the learned machine learning model 902 makes an erroneously determination can be decreased.

Next, a method of the inspection in step S24 in FIG. 2 will be described.

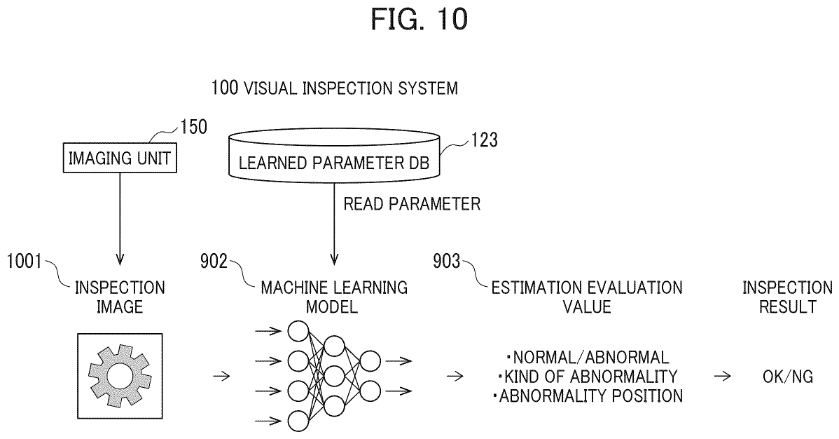

FIG. 10 is a schematic diagram illustrating an example of the inspection method. First, the inspecting unit 115 obtains an inspection image 1001 of a part imaged by the imaging unit 150.

Subsequently, the inspecting unit 115 makes the machine learning model 902 read an inner parameter from the learned parameter DB 123, and then inputs the inspection image 1001 to the machine learning model 902. The machine learning model 902 as a learned model determines whether a part appearing in the inspection image 1001 is normal or abnormal on the basis of the internal parameter, and outputs the estimation evaluation value 903 including the determination result.

In the case where the estimation evaluation value 903 indicates that the part is normal, the inspecting unit 115 determines that the part is not abnormal (OK). On the other hand, when the estimation evaluation value 903 indicates that the part is abnormal, the inspecting unit 115 determines that the part is abnormal (NG).

By the above, the basic process at the time of inspecting a part is finished.

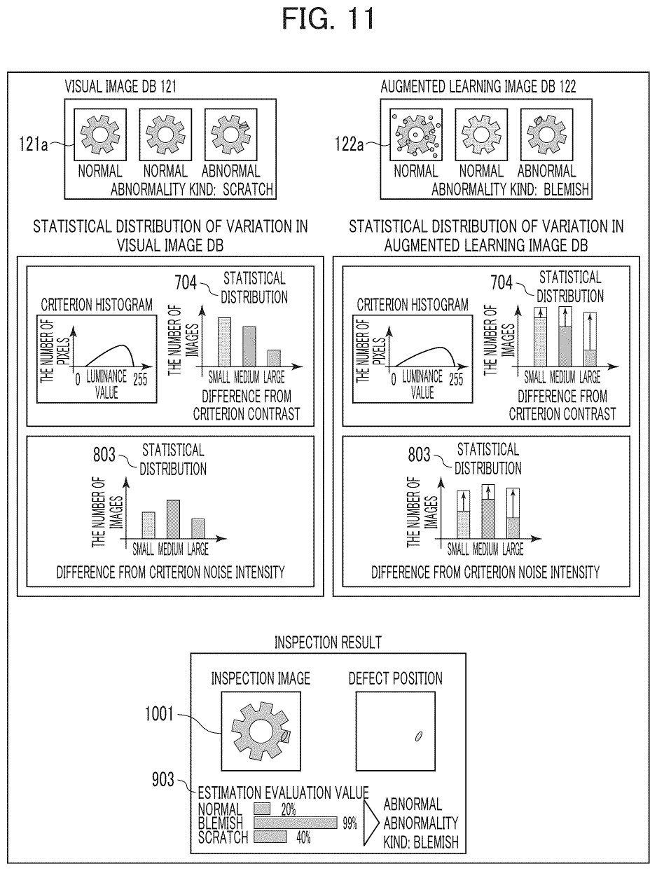

FIG. 11 is a schematic diagram illustrating a display example of the display unit 140. In this example, the display unit 140 displays the visual images 121a in the visual image DB 121. The display unit 140 may display whether it is normal or abnormal indicated by the attribute information 121b and, in the case of an abnormality, also the kind of the abnormality such as “scratch” together with the visual images 121a.

The display unit 140 also displays the augmented learning images 122a in the augmented learning image DB 122. At this time, the display unit 140 may display whether it is normal or abnormal indicated by the attribute information 122b and, in the case of an abnormality, also the kind of the abnormality such as “blemish” together with the augmented learning images 122a.

Further, the display unit 140 displays the statistical distribution in each of the visual image DB 121 and the augmented learning image DB 122. As the statistical distributions, the display unit 140 displays statistical distributions 704 and 803 selected in order to generate additional images in the augmented learning image DB 122. In this case, an additional image 705 generated by using the statistical distribution 704 and an additional image 804 generated by using the statistical distribution 803 are included in the augmented learning images 122a in the augmented learning image DB 122.

In the visual image DB 121, as illustrated in the statistical distribution 704, the number of images becomes smaller as the difference between the criterion contrast and the contrast becomes larger, and the varieties of the visual image 121a are insufficient. On the other hand, in the augmented learning image DB 122, the variation in the statistical distribution 704 is solved as illustrated by the upward arrows, and the number of images becomes almost uniform regardless of large or small of the contrast. This similarly applies to the statistical distribution 803. Consequently, regardless of large or small of the contrast and the average noise intensity, a variety of augmented learning images 122a can be obtained. As a result, by making the machine learning model 902 learn by using the augmented learning images 122a as learning data, a learned model with less erroneous determination can be obtained.

Further, the display unit 140 also displays the result of the inspection performed by the inspecting unit 115. In this example, the display unit 140 displays the inspection image 1001 and the estimation evaluation value 903. The estimation evaluation value 903 includes the probability that a part is normal and the probability that an abnormality such as “blemish”, “scratch”, or the like is included. When there is an abnormality, the display unit 140 also displays the position of a defect.

Therefore, the user can grasp the position of the defect and the kind of the abnormality.

### SECOND EMBODIMENT

In the first embodiment, as illustrated in FIGS. 4 to 8, the image obtaining unit 111 obtains the normal visual images 121a from the visual image DB 121. On the contrary, in a second embodiment, as will be described hereinbelow, the image obtaining unit 111 obtains an abnormal visual image 121a from the visual image DB 121.

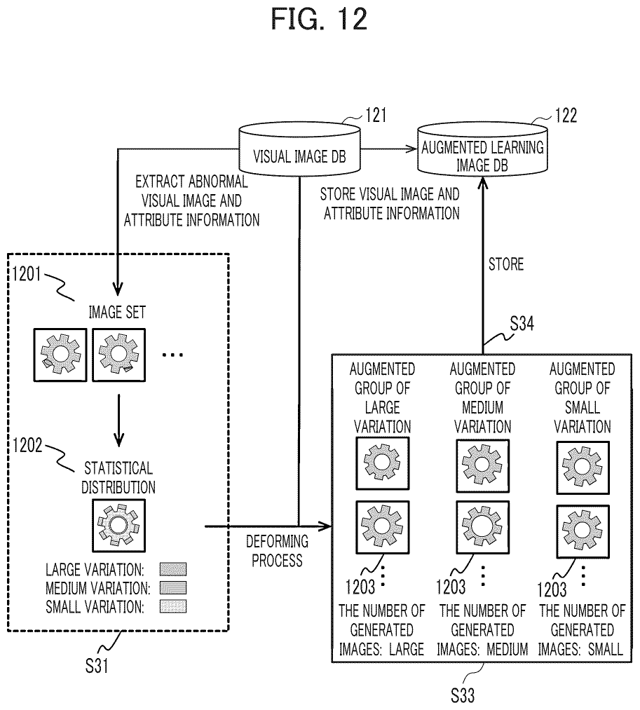

FIG. 12 is a schematic diagram for explaining an example of a process of generating an additional image in the embodiment.

First, in step S21 in FIG. 1, the image obtaining unit 111 obtains one or more abnormal visual images 121a from all of the visual images 121a stored in the visual image DB 121 and their attribute information 121b at random. The obtained visual images 121a are images which become a population of a statistical distribution and will be expressed by an image set 1201 hereinafter.

In step S31, the statistical distribution generating unit 112 specifies a pixel in the position of an abnormality indicated by the attribute information 121b with respect to each of the obtained visual images 121a. Subsequently, the statistical distribution generating unit 112 generates a statistical distribution 1202 indicating the distribution of pixels specified in the image set 1201. The statistical distribution 1202 is a distribution in which the frequencies of occurrence of an abnormality accompanying deformation are expressed by the shades of color. The darker the color in a position is, the more an abnormality frequently occurs and a deformation easily occurs in the position, and the larger the variation in the deformation amount in the position is.

The visual image DB 121 includes abnormal visual images 121a having various deformation amounts. The deformation amounts of many of the abnormal visual images 121a are close to the median value in the image set 1201. It is considered that the number of abnormal visual images 121a having large deformation amount is small statistically.

In step S31, consequently, the image generating unit 113 properly selects the normal visual image 121a from the visual image DB 121. The number of visual images 121a to be selected may be one or plural. The image generating unit 113 performs process such as image process on the selected visual image 121a, thereby generating various additional images 1203 only by the number according to the statistical distribution 1202.

At this time, the larger the variation in the deformation amount in a distribution region in the statistical distribution 1202 is, the more the image generating unit 113 increases the number of additional images 1203. In such a manner, the varieties of the normal additional images 1203 in the distribution region in which an abnormality tends to occur can be increased. The deformation amount of the additional image 1203 is determined according to the statistical distribution 1202 of the abnormal image set 1201.

In step S34, the image generating unit 113 stores all of the visual images 121a included in the visual image DB 121 and all of the additional images 1203 into the augmented learning image DB 122. At this time, the image generating unit 113 also stores the attribute information of each of the visual images 121a and the additional images 1203 into the augmented learning image DB 122.

In such a manner, as described above, the varieties of the normal augmented learning image 122a in the area where an abnormality tends to occur are increased in the augmented learning image DB 122. As a result, the learning unit 114 can accurately learn the discrimination border which distinguishes abnormality and normality, and the possibility that the inspecting unit 115 makes erroneous determination can be reduced.

### THIRD EMBODIMENT

In a third embodiment, an example of using an autoencoder in generation of a learned model in step S23 will be described.

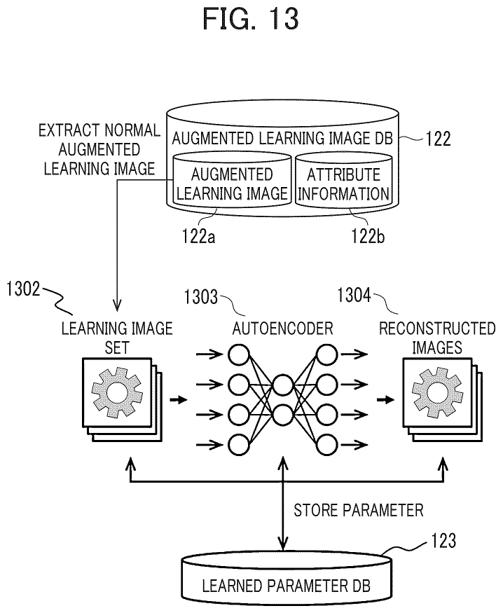

FIG. 13 is a schematic diagram illustrating an example of a method of generating a learned model in the embodiment.

In the embodiment, first, the learning unit 114 obtains one or more normal augmented learning images 122a from the augmented learning image DB 122. Hereinafter, a set of the augmented learning images 122a obtained as described above will be called a learning image set 1302.

Next, the learning unit 114 enters, as correct data, each of the augmented learning images 122a in the learning image set 1302 into an autoencoder 1303. The autoencoder 1303 performs a process on the basis of the internal parameter, and outputs a reconstructed image 1304. Since the autoencoder 1303 is a model of learning so that an input image and the reconstructed image 1304 become the same image, the internal parameter is updated so that the error between the input image and the reconstructed image 1304 becomes the minimum. The learning unit 114 stores the updated internal parameter into the learned parameter DB 123.

After that, the autoencoder 1303 outputs the reconstructed image 1304 by using the internal parameter stored in the learned parameter DB 123. As described above, the autoencoder 1303 which outputs the reconstructed image 1304 by using the internal parameter stored in the learned parameter DB 123 is the learned model in the embodiment.

By the above, the basic process at the time of generating the learned model by using the autoencoder is finished.

Next, a method of the inspection in step S24 in FIG. 2 will be described.

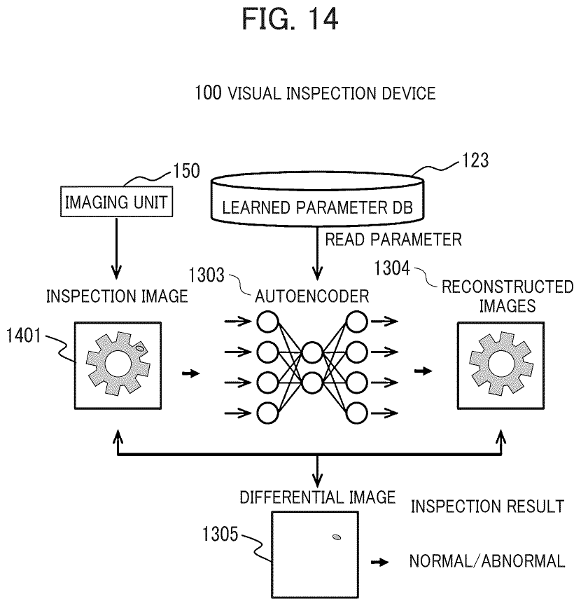

FIG. 14 is a schematic diagram illustrating an example of an inspection method in the embodiment. First, the inspecting unit 115 obtains an inspection image 1401 of a part imaged by the imaging unit 150.

Subsequently, the inspecting unit 115 makes the autoencoder 1303 read the internal parameter from the learned parameter DB 123 and, after that, inputs the inspection image 1401 into the autoencoder 1303. The autoencoder 1303 outputs the reconstructed image 1304 on the basis of the internal parameter.

As illustrated in FIG. 13, since the autoencoder 1303 learns the normal extended learned image 122a as correct data, the normal reconstructed image 1304 having no abnormality is output. Consequently, even when a foreign object is included in the inspection image 1401, the normal reconstructed image 1304 from which the foreign object is removed is output. Therefore, when a foreign object is included in the inspection image 1401, the foreign object is included in a differential image 1305 as the difference between the inspection image 1401 and the reconstructed image 1304.

The inspecting unit 115 determines that a part to be inspected is abnormal when a foreign object is included in the differential image 1305. When no foreign object is included in the differential image 1305, the inspecting unit 115 determines that the part is normal.

By the above, the basic process at the time of inspecting a part in the embodiment is finished. By obtaining the difference between the reconstructed image 1304 output from the autoencoder 1303 and the inspection image 1401, the inspecting unit 115 can inspect whether there is an abnormality in a part or not.

### Hardware Configuration

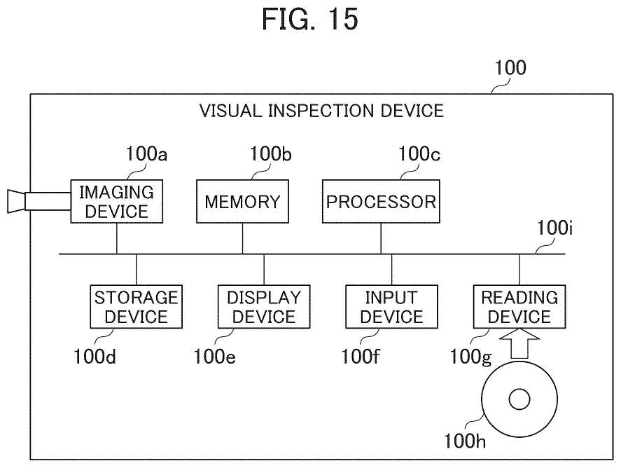

FIG. 15 is a diagram illustrating an example of the hardware configuration of the visual inspection device 100 according to the first to third embodiments.

As illustrated in FIG. 15, the visual inspection device 100 has an imaging device 100a, a memory 100b, a processor 100c, a storage device 100d, a display device 100e, an input device 100f, and a reading device 100g. Those devices are interconnected by a bus 100i.

The imaging device 100a is hardware for realizing the imaging unit 150 in FIG. 1. For example, the imaging device 100a is a camera having an imaging element such as a CCD (Charge Coupled Device) or a CMOS (Complementary Metal Oxide Semiconductor) image sensor for imaging the visual of a part.

The memory 100b is hardware which temporarily stores data like a DRAM (Dynamic Random Access Memory) and on which the program 124 is developed.

The processor 100c is a CPU (Central Processing Unit) or a GPU (Graphical Processing Unit) controlling each of the components of the visual inspection device 100. The processor 100c executes the program 124 in cooperation with the memory 100b, thereby realizing the processing unit 110 in FIG. 1.

The storage device 100d is a nonvolatile storage device such as an HDD (Hard Disk Drive) or SSD (Solid State Drive) and stores the program 124.

It is also possible to record the program 124 in a computer-readable recording medium 100h and make the processor 100c read the program 124 in the recording medium 100h.

The recording medium 100h is, for example, a physical portable recording medium such as a CD-ROM (Compact Disc Read Only Memory), a DVD (Digital Versatile Disc), or a USB (Universal Serial Bus) memory. A semiconductor memory such as a flash memory or a hard disk drive may be used as the recording medium 100h.

The program 124 may be stored in a device connected to a public line, the Internet, a LAN (Local Area Network), or the like. In this case, the processor 100c reads and executes the program 124.

The storing unit 120 in FIG. 1 is realized by the memory 100b and the storage device 100d.

The display device 100e is hardware such as a liquid crystal display or an organic EL display for realizing the display unit 140 in FIG. 1. The input device 100f is hardware such as a keyboard or a mouse for realizing the input unit 130 in FIG. 1.

The reading device 100g is hardware such as a CD drive for reading data recorded in the recording medium 100h.

The effects described in the specification are just an example. The effects are not limited to them. There may be other effects.

It should be noted that the present invention is not limited to the embodiments described above, and includes various modifications. For example, although the visual inspection device 100 has the imaging unit 150 in the example of FIG. 1, the imaging unit 1500 may be provided on the outside of the visual inspection device 100. In this case, it is sufficient to connect the imaging unit 150 and the visual inspection device 100 by a not-illustrated network such as a LAN or the Internet and store the visual image 121a captured by the imaging unit 150 into the visual image DB 121 by the visual inspection device 100. By employing such a configuration, the learning unit 114 generates a learned model by using the augmented learned images 122a including the visual image 121a as learning data, and cloud service which outputs an internal parameter of the learned model can be realized by the visual inspection device 100.

The embodiments described above have been described in detail to simply describe the present invention, and are not necessarily required to include all the described configurations. In addition, part of the configuration of one embodiment can be replaced with the configurations of other embodiments, and in addition, the configuration of the one embodiment can also be added with the configurations of other embodiments. In addition, the configuration of each of the embodiments can be subjected to addition, deletion, and replacement with respect to other configurations.

Each of the above-described configurations, functions, processing units, processing means, and the like may be partially or entirely realized by hardware by designing, for example, with an integrated circuit. Each of the above-described configurations, functions, and the like may be realized by software when a processor interprets and executes a program realizing each of the functions. Information of a program realizing each function, a determination table, a file, and the like can be stored in memory, a storing device such as an HDD or SDD, or a recording medium such as an IC (Integrated Circuit) card, an SD (Secure Digital) card, or a DVD (Digital Versatile Disc). The control lines and information lines which are regarded as necessary for description are illustrated, and all of control lines and information lines in the product are not always illustrated.

It may be considered that almost all of the components are interconnected in practice.

### LIST OF REFERENCE SIGNS

100 . . . visual inspection device, 110 . . . processing unit, 111 . . . image obtaining unit, 112 . . . statistical distribution generating unit, 113 . . . image generating unit, 114 . . . learning unit, 115 . . . inspecting unit, 120 . . . storing unit, 121a . . . visual image, 121b . . . attribute information, 122a . . . augmented learning image, 122b . . . attribute information, 124 . . . program, 130 . . . input unit, 140 . . . display unit, 150 . . . imaging unit, 401, 501, 601, 701, 801, 1201. image set, 402 criterion-value image, 403, 503, 602, 704, 803, 1202 . . . statistical distribution, 404, 504, 604, 705, 804, 1203 . . . additional image, 502 . . . criterion-value image, 505 . . . abnormality template, 702 . . . luminance histogram, 703 . . . criterion histogram, 802 . . . denoised image, 901 . . . learning image set, 902 machine learning model, 903 . . . estimation evaluation value, 1001 . . . inspection image, 1302 . . . learning image set, 1303 . . . autoencoder, 1304 . . . reconstructed image, 1305 . . . differential image, 1401 . . . inspection image

1. A visual inspection device having a processor, wherein
the processor
obtains a plurality of visual images of visual of an object to be inspected,
generates a statistical distribution expressing variation in a characteristic of each of the visual images when the plurality of visual images are set as a population,
generates an additional image of the visual on the basis of the variation indicated by the statistical distribution, and
generates a learned model by machine learning using learning data including the plurality of visual images and the additional images.
wherein the larger the variation in a distribution region in the statistical distribution is, the more the processor increases the number of additional images for the distribution region.

2. (canceled)

3. The visual inspection device according to claim 2, wherein
the characteristic is a deformation amount of the object to be inspected appearing in the visual image.

4. The visual inspection device according to claim 2, wherein
the characteristic is a position where a deformation occurs in the object to be inspected appearing in the visual image, and
the processor generates the additional image by superimposing a defect on the position in the visual image.

5. The visual inspection device according to claim 1, wherein
the smaller the number of visual images in a distribution region in the statistical distribution is, the more the processor increases the number of the additional images for the distribution region.

6. The visual inspection device according to claim 5, wherein
the characteristic is any of luminance, contrast, and noise intensity of the visual image.

7. The visual inspection device according to claim 1, wherein
the processor further inspects whether there is an abnormality in the object to be inspected which is appearing in an inspection image by using the learned model.

8. The visual inspection device according to claim 7, wherein
the learned model is an autoencoder which learns the learning data as correct data, and
the processor enters the inspection image to the autoencoder and determines whether a foreign matter is included in a differential image as the difference between a reconstructed image output from the autoencoder and the inspection image, thereby inspecting whether or not there is an abnormality in the object to be inspected.

9. The visual inspection device according to claim 1, wherein
each of the plurality of visual images is an image of the visual of the object to be inspected which is normal.

10. The visual inspection device according to claim 1, wherein
each of the plurality of visual images is an image of the visual of the object to be inspected which is abnormal.

11. The visual inspection device according to claim 9, wherein
the processor processes an image of the visual of the object to be inspected which is normal, to generate the additional image indicating a normality.

12. The visual inspection device according to claim 9, wherein
the processor processes an image of the visual of the object to be inspected which is normal or abnormal, to generate the additional image indicating an abnormality.

13. An image generating method that makes a computer execute:
a step of obtaining a plurality of visual images of visual of an object to be inspected;
a step of generating a statistical distribution expressing variation of a characteristic of each of the visual images when the plurality of visual images are set as a population;
a step of generating an additional image of the visual on the basis of the variation indicated by the statistical distribution; and
a step of generating a learned model by machine learning using learning data including the plurality of visual images and the additional images.
wherein the larger the variation in a distribution region in the statistical distribution is, the more the processor increases the number of additional images for the distribution region.
